(19) United States
(12) Patent Application Publication
(10) Pub. No.: US 2015/0198226 A1
(43) Pub. Date: Jul. 16, 2015

(54) Hydraulic variable drive train

(71) Applicant: Manuel Meitin, Miami, FL (US)

(72) Inventor: Manuel Meitin, Miami, FL (US)

(21) Appl. No.: 13/999,093

(22) Filed: Jan. 13, 2014

(51) Int. Cl. F16H 41/02

(52) U.S. Cl. CPC F16H 41/02

(57) ABSTRACT

A gradual transmission for automobiles, industrial devices, and other appliances requiring a continuously gradual torque, which includes: a hydraulic pump connected to the output shaft of a combustion engine or any other motive power supply, for providing a hydraulic pressure to a hydraulic motor which is also connected to the driving wheels of a vehicle or optionally to any industrial equipment. The resultant torque transmission can be manually operated, or controlled by any other automatic device.

### CLAIM OF PRIORITY

The present application is based on and a claim of priority is made under 35 U.S.C. Section 119 (e) to a provisional patent application that is currently pending in the U.S. Patent and Trademark Office, namely, that having Ser. No. 61/849,701 and a filing date of Feb. 1, 2013.

### REFERENCES CITED

U.S. PATENT DOCUMENTS

| | | | |
|---|---|---|---|
| 8,322,252 | December 2012 | Crowin | 74/730 |
| 8,333,131 | December 2012 | Legner | 74/130 |
| 8,225,917 | July 2012 | Yamashita | 192/3.29 |
| 8,152,673 | April 2012 | Yanay | 475/93 |
| 7,905,337 | March 2011 | Degler | 192/3.29 |
| 7,775,335 | August 2010 | Maienschein | 192/3.2 |

### BACKGROUND OF THE INVENTION

1. Field of the Invention

This invention relates to a gradual transmission for automobiles, motorcycles and industrial devices requiring a steeples variable torque, and more particularly to a gradual and variable transmission combined with an internal combustion engine for vehicles or with an electric industrial motor.

Continuously variable transmissions can provide a better fuel economy than other transmissions by enabling the engine to run at its most efficient rotation for a range of vehicle speeds improving the performance of an automobile.

2. Description of the Related Art

A typical automatic transmission usually comprises a hydraulic torque converter, a planetary gear assemble, some brake systems and a control device, for transmitting a torque generated by an internal combustion engine to the driving wheels, wherein the torque is usually transmitted in several stages.

A more recently developed transmission known as continuously variable transmission includes a set of adjustable pitch pulleys in cooperation with a belt for variably transmitting the torque from drive engine of the vehicle to the driving wheels thereof. Belt structures of the type referred to have been improved several times in order to provide an acceptable resistance against breaking and wear. However, only a limited torque can be transmitted using such technology.

According to the present invention, the torque generated by the vehicle engine is gradually transmitted to the driving wheels combining the operative features of an automatic transmission with the performance and benefits of a continuously variable transmission.

As a result, the preferred embodiments of the present invention are suitable for use on any current automobile, as well as for industrial uses. Moreover, the practical results in doing so include an improve in fuel economy, a reduction in emissions from engine exhaust gases, lower production cost, and increased durability.

### SUMMARY OF THE INVENTION

It is therefore an object of the present invention to provide an improved gradual transmission for automobiles and also for industrial uses.

It is another object of the invention to provide improvements in performance if compared with current automatic or manual transmissions.

It is further object of the invention to provide a gradual transmission for improving fuel efficiency.

These and other objects, features and advantages of the present invention will become more clear when the drawings as well as the detailed description are taken into consideration.

### BRIEF DESCRIPTION OF THE DRAWINGS

For a fuller understanding of the nature of the present invention, reference should be had to the followings in which:

FIG. 1 illustrates the first embodiment of the transmission of the present invention ion which: 1—input shaft, 2—hydraulic pump impeller, 3—oil intake, 4—oil pump body, 5—oil passage, 6—control valve, 7—hydraulic motor impeller, 8—output shaft, 9—oil exhaust port, 10—transmission body, P—hydraulic pump, M—hydraulic motor.

FIG. 2 illustrates a second embodiment of the transmission of the present invention in which numbers 1 through 10 represent the same as in FIG. 1, including P and M; 11—is a one way clutch, and 12 is a brake.

Like reference numeral refer to like parts throughout the several views of the drawings

### DETAILED DESCRIPTION OF THE PREFERRED EMBODIMENT

The present invention is directed to a hydraulic gradual transmission structured to gradually transmit a variable torque, without steps, from the internal combustion of the vehicle to the driving wheels.

More specifically, the various embodiments of the present invention include a hydraulic pump, a hydraulic motor and a hydraulic control valve. In addition a connector assembly is added in a second embodiment. As pointed out in greater detail, the connector assembly comprises a free wheeling device in cooperation with a brake and a fluid control valve which facilitates the movement and non-movement of said hydraulic pump body. As such, the various preferred embodiments of the present invention are structured to gradually vary the torque, generated by the internal combustion engine or other drive engine of the vehicle, which is transmitted as needed to the driving wheels of the vehicle.

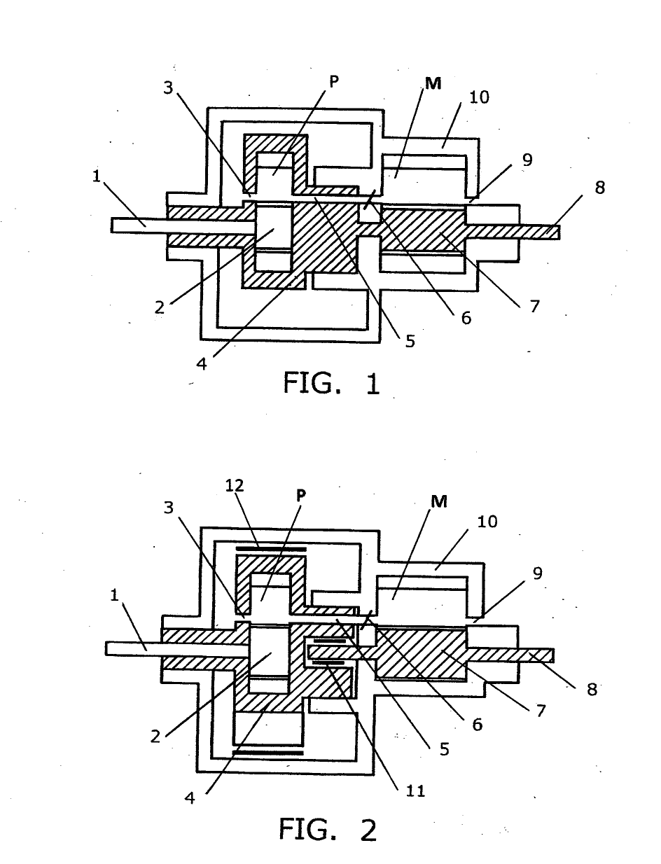

Accordingly and with primary reference to the preferred embodiment of FIG. 1, engine torque and rotation are transmitted, by means of input shaft 1, from the drive motor to the hydraulic pump impeller 2. The hydraulic pump body 4 is connected to the hydraulic motor impeller 7 which is permanent fixed to the output shaft 8 and then to the driving wheels which are initially motionless.

On the other hand, oil from the bottom of the transmission casing 10 enters inside the oil pump P through oil intake port 3 which flows to the hydraulic motor M, crossing through oil passage 5 and fluid control valve 6 which is initially open.

In order to increase the torque needed for start moving the driving wheels of the vehicle, the oil capacity of said hydraulic motor M must be greater than the oil pump P itself.

Inasmuch as the driving wheels of the vehicle are in motion, said hydraulic pump body 4 starts moving too, because of the interconnection between said body pump 4, hydraulic motor impeller 7, output shaft 8, and said driving wheels, in such a way that a reduction of oil flow takes place, taking into account that relative movement between impeller 2 and pump body 4 becomes smaller in the same way as the driving wheels reach a higher rotation, any way, some degree of sliding always takes place between impeller 2 and pump body 4 then, a fluid control valve 6 placed at the exit of the pump P must be gradually moved to its full closed position, by means of a control device C, or manually, avoiding that oil inside said pump can go out, resulting in dragging the body 4 together with the impeller 2. If torque demand becomes higher than required, said control valve 6 is gradually moved to a partial open position or to a full open position, in such a way that an increase in torque can be reached as needed because oil pump 4 is not dragged at all and its rotation becomes lower relative to impeller 2, allowing oil inside the pump P to flow out to the hydraulic motor M through control valve 6.

In accordance with the second embodiment, as shown in FIG. 2, engine torque and rotation are transmitted by means of the input shaft 1 to the impeller 2. As a result oil is sucked through intake port 3 from the bottom of the case 10, and pumped to the hydraulic motor M, while fluid control valve 6 in open position, in such a way that the higher torque provided by the mechanism promoted by the difference of volume between pump P and motor M, is transmitted from impeller 7 and output shaft 8 to the driving wheels. In order to ensure the highest volume of oil delivered to said hydraulic motor M, the rotation of pump body 4 is initially braked by the action of brake 12 which is placed at a closed distance of the said pump P periphery.

Once the higher torque is obtained, said brake 12 must be released at the same time as fluid control valve 6 is also gradually closed too, allowing a partial, to a full drag of pump body 4. At the point in which hydraulic control valve 6 is fully closed, oil inside the pump P can not go away, then said pump body 4 is dragged with impeller 2, as a unit, without a significant sliding, in such a way that the resultant torque rate is close to 1:1, taking into account some minor sliding because of marginal loses and internal frictions of the mechanism.

A one way clutch 11 is placed at the exit of the pump body 4, allowing a mechanical transmission of power between pump P and output shaft 8 when brake 12 is released and hydraulic control valve 6 is closed. On the other hand when brake 12 is oppressed against the surface of said pump body 4 and said hydraulic control valve 6 is open, oil entering motor M produce an increase in resultant torque which is transmitted to the output shaft 8 and then to the driving wheels. Several opening positions of said hydraulic control valve 6 determines the amount of oil flowing out from pump P to hydraulic motor M, resulting in a partial sliding between impeller 2 and body 4. Hydraulic control valve 6 opening and close and brake 12 operation can be manually operated or optionally, by automatic devices not described here.

What is claimed is:

1. A hydraulic variable drive train for a motor driven vehicle and also for industrial equipments, comprising:
a floating hydraulic pump connected to an output of a vehicle engine, or to an electric motor when used in industrial devices.
a hydraulic motor connected to said hydraulic pump, for converting and transmitting the torque generated by the vehicle engine to the driving wheels, or for converting and transmitting the torque generated by an electric motor to any industrial device.
a hydraulic control flow valve for regulating the amount of oil passing from said hydraulic pump to said hydraulic motor.

2. A hydraulic variable drive train for a motor driven vehicle and also for industrial equipments, comprising:
a floating hydraulic pump connected to an output of a vehicle engine, or to an electric motor when used in industrial devices.
a hydraulic motor eventually connected to said hydraulic pump, for converting and transmitting the torque generated by the vehicle engine to an output shaft and then to the driving wheels, or for converting or transmitting the torque generated by an electric motor to an output shaft.
a connector assembly for eventually connecting said hydraulic pump to said hydraulic motor.
a hydraulic control flow valve for regulating the amount of oil passing from said hydraulic pump to said hydraulic motor.
a brake assembly, for eventually stopping the body rotation of said floating hydraulic pump.

3. A hydraulic variable drive train as recited in claim 2, wherein said connector assembly comprises, a free wheeling device structured for providing the independence of rotation and non-rotation of said hydraulic pump body.
